(19) United States
(12) Patent Application Publication
(10) Pub. No.: US 2026/0288223 A1
(43) Pub. Date: Sep. 24, 2026

(54) POWER-SUPPLY MANAGEMENT DEVICE AND POWER-SUPPLY MANAGEMENT METHOD

(71) Applicant: UFI SPACE CO., LTD., New Taipei City (TW)

(72) Inventors: Ko-Wen WANG, New Taipei City (TW); Yu-Hsin CHEN, New Taipei City (TW)

(21) Appl. No.: 19/086,596

(22) Filed: Mar. 21, 2025

(51) Int. Cl. G06F 1/3228

(52) U.S. Cl. CPC G06F 1/3228

(57) ABSTRACT

A power-supply management device sends a control command including a plurality of data fields to a power supply unit; accesses a time data and acquires a plurality of time segments of the time data by sections from the least significant bit according to a reading length; carries the plurality of time segments from the least significant bit to the first of the plurality of data fields until all the time segments are carried to the plurality of data fields; and decodes the control command, and by an order starting from the time segment last carried to the data field, assemble the plurality of time segments to obtain a power-on time of the power supply unit.

### BACKGROUND OF THE DISCLOSURE

### Technical Field

The disclosure relates to a management device and a management method, and particularly to a power-supply management device and a power-supply management method.

### Description of Related Art

To ensure the electronic device operates stably during the powered-on period and to prevent malfunction problems or other issues caused by the end of the lifetime, factors such as temperature, humidity, current, voltage, charge-discharge cycles, or operating time of the electronic device are monitored to evaluate the status of the electronic device.

In the existing method of detecting the lifetime of the electronic device, a detection device can monitor one or more pivot parameters (e.g., temperature, vibration, current) by sensors and use the sensing data to establish a lifetime model. However, the lifetime model requires complex mathematical calculations, and it also requires time to verify the accuracy. Furthermore, once the quantity of electronic devices increases or changes, it is difficult to effectively manage the usage condition of the electronic devices.

### SUMMARY OF THE DISCLOSURE

Accordingly, the power-supply management device and the power-supply management method are provided to effectively manage the usage of the power supply unit.

One of the exemplary embodiments is to provide a power-supply management device including a power supply unit and a processor. The power supply unit includes a memory, where the memory stores a time data. The processor is connected to the power supply unit and configured to send a control command comprising a plurality of data fields to the power supply unit; access the time data and acquire a plurality of time segments of the time data by sections from a least significant bit (LSB) of the time data according to a reading length; carry the plurality of time segments from the LSB of the time data to first of the plurality of data fields until all the plurality of time segments are carried to the plurality of data fields; and decode the control command, and by an order starting from the time segment last carried to the plurality of data fields, assemble the plurality of time segments to obtain a power-on time of the power supply unit.

One of the exemplary embodiments is to provide a power-supply management method applied to a power supply unit, including steps of: sending a control command comprising a plurality of data fields to the power supply unit; accessing a time data stored in a memory of the power supply unit and acquiring a plurality of time segments of the time data by sections from a least significant bit (LSB) of the time data according to a reading length; carrying the plurality of time segments from the LSB of the time data to first of the plurality of data fields until all the plurality of time segments are carried to the plurality of data fields; and decoding the control command, by an order starting from the time segment last carried to the plurality of data fields, assembling the plurality of time segments to obtain a power-on time of the power supply unit.

### BRIEF DESCRIPTION OF THE DRAWINGS

FIG. 1 is a block diagram illustrating a power-supply management device according to an embodiment of the disclosure.

FIG. 2 is a section diagram of the time data according to an embodiment of the disclosure.

FIG. 3 is a diagram of the control command format according to an embodiment of the disclosure.

FIG. 4 is a mapping diagram illustrating the time segment carried to the data field of the control command according to an embodiment of the disclosure.

FIG. 5 is a diagram illustrating an assembly of the plurality of the time segments based on the decoding control command to obtain the total power-on time of the power supply unit according to an embodiment of the disclosure.

FIG. 6 is a flowchart of the power-supply management method according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The Common Redundant Power Supply (CRPS) is utilized as a norm of the power module of servers or storage. In the CRPS, the power-supply management device executes the control command (e.g., 0xDC command) to read a diagnosis data of length 289 bytes from the memory of the power supply unit and decodes the diagnosis data for the total power-on time of the power supply unit (e.g., the total time that the power supply unit has been in operation for a certain duration since being turned on). Therefore, the power-supply management unit can confirm the total power-on time of the power supply unit and evaluate the life-cycle residual time of the power supply unit.

It should be noted that the total power-on time recorded by the power supply unit is 3 bytes. In other words, the power-supply management unit obtains the total power-on time of the length 3 bytes by decoding the diagnosis data of length 238 bytes (including 1 byte of the error correction code in the transmission). In the case of the transmission speed between the power-supply management device and the power supply unit is 1K Hz, the power-supply management device costs 19.12 milliseconds

$$( \frac{1}{100 k} ( sec ) \times 8 ( bit ) \times 239 )$$

to obtain information on the total power on time. The 0xDC command of the CRPS relatively consumes the time of the power-supply management device to obtain the total power on time.

In the following embodiments, the power-supply management device can significantly reduce the transmission time for accessing the total power-on time of the power supply unit.

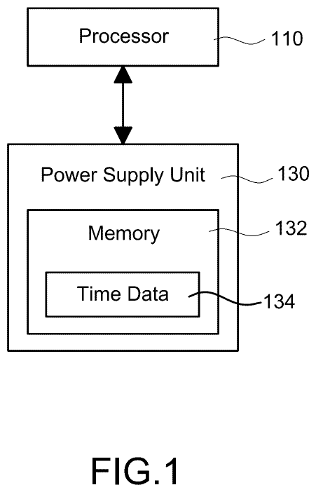

FIG. 1 is a block diagram illustrating a power-supply management device according to an embodiment of the disclosure.

As shown in FIG. 1, the power-supply management device includes a processor 110 and a power supply unit 130. The processor 110 is connected to the power supply unit 130. In one embodiment, the processor 110 and the power supply unit 130 communicate through a transmission interface (such as I2C protocol (Inter-Integrated Circuit), UART protocol, or CAN protocol (Controller Area Network Protocol)).

The power supply unit 130 includes a memory 132. The memory 132 stores a time data 134. In one embodiment, the time data 134 is a total power-on time autonomously recorded by the power supply unit 130 since the power supply unit 130 was powered up.

In one embodiment, the power supply unit 130 is the power supply device compatible with the Common Redundant Power Supply (CRPS) and utilizes the control command of the CRPS, such as 0xBD command or other reserved commands.

In another embodiment, the power-supply management device includes a plurality of processors (not shown in figures) and a plurality of power supply units (not shown in figures). A processor may monitor the operation conditions of one or more power supply units. For brevity, the following takes the scenario of FIG. 1 as one embodiment.

The processor 110 may be but is not limited to the Digital Signal Processors (DSP), the Application Specific Integrated Circuit (ASIC), the central processing unit (CPU), the System on Chip (SoC), the Field Programmable Gate Array (FPGA), the network processor chip, or any combination of the elements above.

The memory 132 may be but is not limited to the Random Access Memory (RAM), the Flash memory, the Read Only Memory (ROM), the Hard Disk Drive (HDD), the Solid State Drive (SSD), the optical storage, or any combination of the elements above.

In one embodiment, the processor 110 of the power-supply management device sends the control command including a plurality of data fields (or called protocol packet format) to the power supply unit 130 to access the time data 134 based on the control command. The processor 110 accesses the time data 134, and based on a reading length that is regarded as a time segment, acquires a plurality of time segments of the time data 134 by sections from the least significant bit (LSB) of the time data 134 to obtain a plurality of time segments sequentially. The plurality of the time segments are carried to the plurality of the data fields, starting from the LSB segment of the time data 134 being carried to the first data field, until all time segments are carried to the plurality of data fields. After the processor 110 receives the data by the control command, the processor 110 decodes the contents of the control command and assembles the plurality of time segments from the contents of the plurality of data fields, starting from the time segment the last carried to the data field by sequence to obtain the total power-on time of the power supply unit 130.

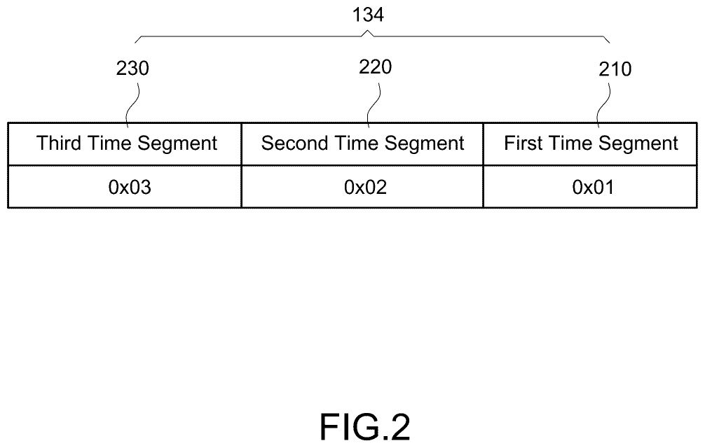

In one embodiment, a data size of the time data 134 of the power supply unit 130 is 3 bytes, and the time data 134 is segmented into 3 time segments, each time segment is 1 byte. Reference is made to FIG. 2. FIG. 2 is a section diagram of the time data according to an embodiment of the disclosure.

The time data 134 is the total power-on time of the power supply unit 130, setting the time unit minutes. For example, the content of the time data 134 is 197121 minutes, then 197121 minutes is (030201)ₕₑₓ in hexadecimal or “0x03 0x02 0x01” shown in FIG. 2.

In one embodiment, the processor 110 reads the plurality of time segments of the time data 134 from the LSB of the time data 134 based on the reading length. In other words, based on the reading length of 8 bits, (030201)ₕₑₓ is divided into 3 time segments from the LSB, that is, a first time segment 210, a second time segment 220 and a third time segment 230. In the embodiment, the content of the first time segment 210 is (01)ₕₑₓ, the content of the second time segment 220 is (02)ₕₑₓ, and the content of the third time segment 230 is (03)ₕₑₓ.

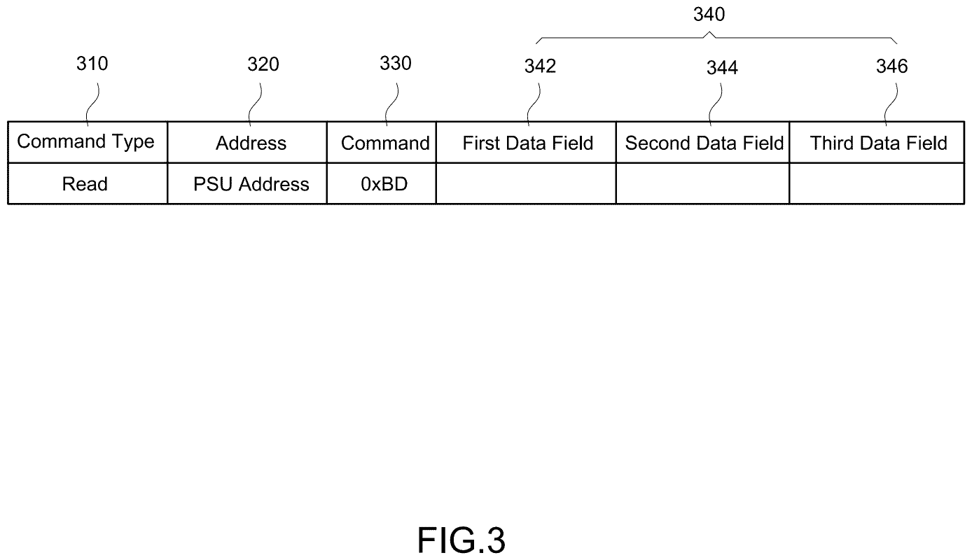

FIG. 3 is a diagram of the control command format according to an embodiment of the disclosure.

In the control command format, the plurality of the data fields include a command type 310, an address 320, a command 330, and a data field 340.

In one embodiment, the command type 310 is ‘read’, i.e., the control command used for accessing the power supply unit 130.

In one embodiment, the content of the address 320 is a PSU address, i.e., the address of the memory 132 storing the time data 134 of the power supply unit 130.

In one embodiment, the content of the command 330 is 0xBD or other reserved commands.

In one embodiment, the data field 340 includes a first data field 342, a second data field 344, and a third data field 346. The length of the data field 340 is 24 bits, each data field is 8 bits.

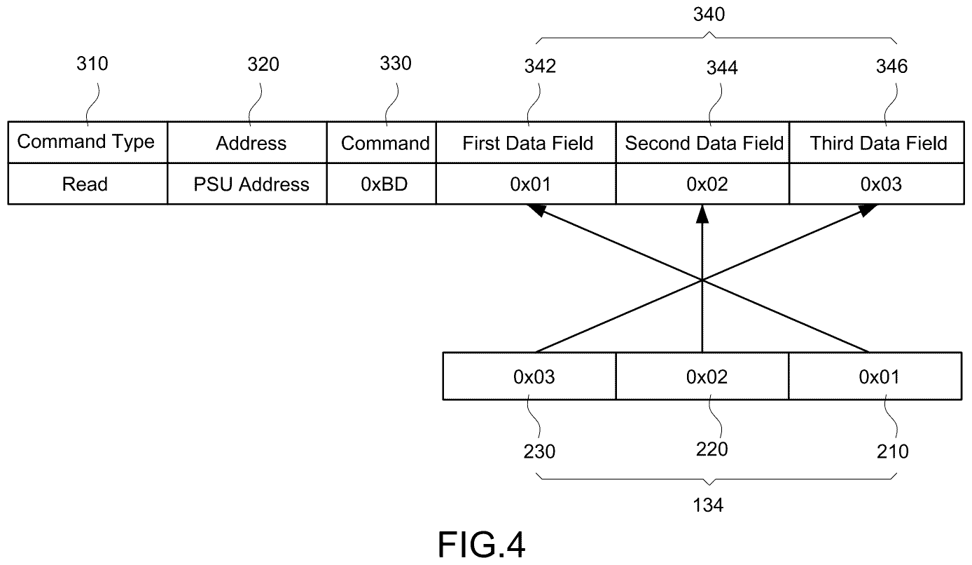

FIG. 4 is a mapping diagram illustrating the time segment carried to the data field of the control command according to an embodiment of the disclosure.

Starting from the LSB of the time data 134, the processor 110 sequentially acquires the first time segment 210, the second time segment 220, and the third time segment 230 of the plurality of time segments, where the first data field 342 carries the first time segment 210, the second data field 344 carries the second time segment 220, and the third data field 346 carries the third time segment 230. That is, the contents of the first data field 342, the second data field 344, and the third data field 346 are reversely ordered, based on the LSB of the plurality of time segments of the time data 134.

In one embodiment, as shown in FIG. 4, from the LSB of the time data 134 (such as the value 1 in hexadecimal of FIG. 4), the first time segment 210 is obtained based on the reading length of 8 bits, and the data “0x01” of the first time segment 210 is carried to the first field of the data field 340, i.e., the first data field 342. The second time segment 220 is obtained based on the reading length of 8 bits, and the data “0x02” of the second time segment 220 is carried to the second data field 344. The third time segment 230 is obtained based on the reading length of 8 bits, and the data “0x03” of the third time segment 230 is carried to the third data field 346. In the embodiment, the content of the data field 340 is “0x01 0x02 0x03”, the reverse arrangement based on the LSB of the time data “0x03 0x02 0x01”.

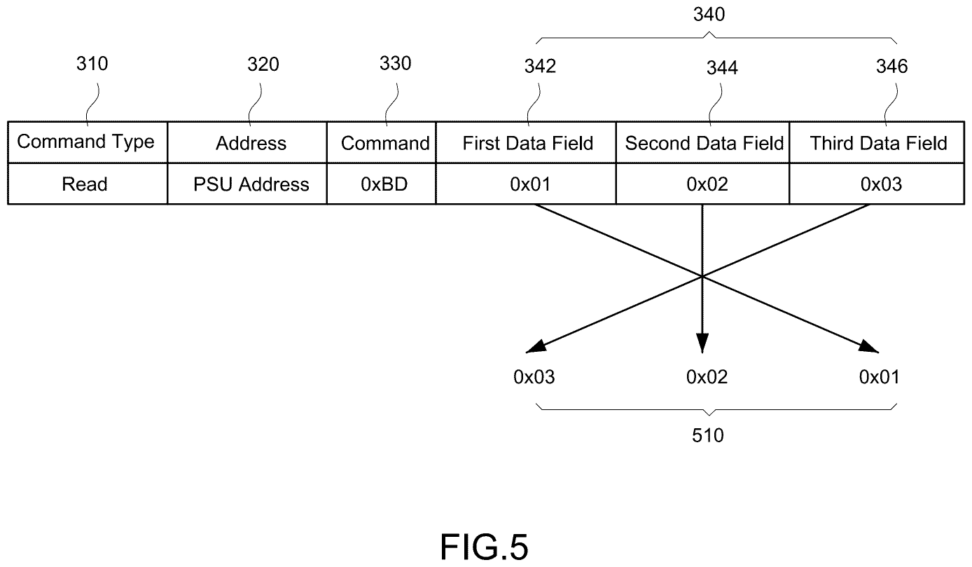

FIG. 5 is a diagram illustrating an assembly of the plurality of the time segments based on the decoding control command to obtain the total power-on time of the power supply unit according to an embodiment of the disclosure.

As shown in FIG. 5, after the processor 110 decodes the control command, the contents of the plurality of the data fields are obtained. For example, the content of the first data field 342 is “0x01”, the content of the second data field 344 is “0x02”, and the content of the third data field 346 is “0x03”. The processor 110 assembles the contents of the three data fields, starting from the time segment last carried to the data field, such as from the third data field 346, and then the second data field 344 to the first data field 342 (in the reverse arrangement), to obtain the total power-on time 510 of the power supply unit 130, such as “(030201)ₕₑₓ” in hexadecimal or 197121 (minutes) in decimal.

In one embodiment, when the processor 110 assembles the first time segment 210, the second time segment 220, and the third time segment 230 to obtain the total power-on time 510, the processor 110 utilizes the Packet Error Check code (PEC) to examine whether the total power-on time 510 satisfies the integrity (e.g. the computational error during the assembly process or packet loss during data transmission will cause the lack of integrity), where the PEC is 8 bits.

In the embodiment, the power-supply management device decodes the control command to obtain the time data of 3 bytes (including the error correction code of 1 byte in transmission). If the transmission speed between the power-supply management device and the power supply unit 130 is 1K Hz, the power-supply management device needs only 0.32 milliseconds

$$( \frac{1}{100 k} ( sec ) \times 8 ( bit ) \times 4 )$$

to obtain the time data. Compared with the related art requiring 19.12 milliseconds, the disclosure only requires 0.32 milliseconds, significantly reducing the transmission time on reading the total power-on time of the power supply unit.

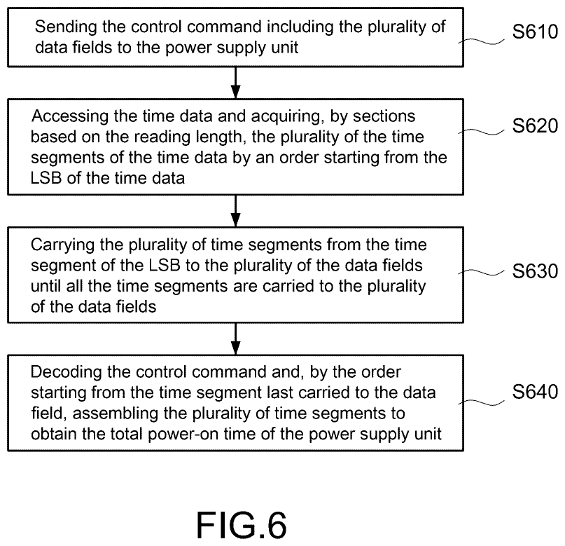

FIG. 6 is a flowchart of the power-supply management method according to an embodiment of the disclosure.

In one embodiment, the power-supply management method may be performed by the power-supply management device of FIG. 1 to obtain the total power-on time of the power supply unit 130.

In step S610, the processor 110 sends the control command including the plurality of data fields to the power supply unit 130.

In step S620, the processor 110 accesses the time data 134 and acquires by sections, based on the reading length, the plurality of the time segments of the time data 134 by an order starting from the LSB of the time data 134.

In step S630, the processor 110 carries the plurality of time segments to the plurality of the data fields, where the time segment of the LSB is carried to the first of the data fields, until all the time segments are carried to the plurality of the data fields.

In step S640, the processor 110 decodes the control command and, by the order starting from the time segment last carried to the data field, assembles the plurality of time segments to obtain the total power-on time 510 of the power supply unit.

In one embodiment, the data field 340 is 24 bits, and the maximal value of the hexadecimal is (FFFFFF)ₕₑₓ, about 16777215 minutes. In other words, the control command can record the maximum time length of approximately 32 years. In one embodiment, according to the default maximum length of the time data of the power supply unit, the quantity of fields of the data field 340 used by the control command can be adjusted based on the actual situation and is not limited herein. For example, the quantity of fields of the data field 340 is 3.

In one embodiment, the power-supply management device includes a display (not shown in figures). After the power-supply management device obtains the total power-on time of the power supply unit 130, the display shows the total power-on time to the users.

Accordingly, compared with the related art requiring the process of accessing the data of 238 bytes and costing time of 19.12 milliseconds to obtain the time data, the power-supply management device and the power-supply management method of the disclosure requires only the process of accessing the data of 4 bytes and costing the time of 0.32 milliseconds, so the time of accessing and transmission data is efficiently reduced and the access efficiency is enhanced.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A power-supply management device, comprising:
a power supply unit, comprising a memory, the memory storing a time data; and
a processor, connected to the power supply unit and configured to:
send a control command comprising a plurality of data fields to the power supply unit;
access the time data and acquire a plurality of time segments of the time data by sections from a least significant bit (LSB) of the time data according to a reading length;
carry the plurality of time segments from the LSB of the time data to first of the plurality of data fields until all the plurality of time segments are carried to the plurality of data fields; and
decode the control command, and by an order starting from the time segment last carried to the plurality of data fields, assemble the plurality of time segments to obtain a power-on time of the power supply unit.

2. The power-supply management device of claim 1, wherein the plurality of data fields comprise a first data field, a second data field, and a third data field, and the plurality of time segments acquired by the order starting from the LSB of the time data by the processor comprise a first time segment, a second time segment, and a third time segment, wherein the first data field carries the first time segment, the second data field carries the second time segment, and the third data field carries the third time segment, so contents of the first data field, the second data field, and the third data field are reversely arranged related to the LSB of the time data.

3. The power-supply management device of claim 1, wherein fields of the control command comprise an address, and a content of the address is a memory address storing the time data of the power supply unit.

4. The power-supply management device of claim 1, wherein the control command is BDh command or a reserved command of Common Redundant Power Supply (CRPS).

5. The power-supply management device of claim 2, wherein lengths of the first data field, the second data field, and the third data field are respectively 8 bits, a reading length is 8 bits, and the processor assembles the first time segment, the second time segment, and the third time segment to obtain the total power-on time of length 24 bits.

6. The power-supply management device of claim 2, wherein when the processor assembles the first time segment, the second time segment, and the third time segment to obtain the total power-on time, the processor utilizes a packet error check code to examine whether the total power-on time satisfies the integrity, wherein the packet error check code is 8 bits.

7. A power-supply management method, applied to a power supply unit, comprising:
sending a control command comprising a plurality of data fields to the power supply unit;
accessing a time data stored in a memory of the power supply unit and acquiring a plurality of time segments of the time data by sections from a least significant bit (LSB) of the time data according to a reading length;
carrying the plurality of time segments from the LSB of the time data to first of the plurality of data fields until all the plurality of time segments are carried to the plurality of data fields; and
decoding the control command, by an order starting from the time segment last carried to the plurality of data fields, assembling the plurality of time segments to obtain a power-on time of the power supply unit.

8. The power-supply management method of claim 7, wherein the plurality of data fields comprise a first data field, a second data field, and a third data field, and the plurality of time segments acquired by the order starting from the LSB of the time data comprise a first time segment, a second time segment, and a third time segment, wherein the first data field carries the first time segment, the second data field carries the second time segment, and the third data field carries the third time segment, so contents of the first data field, the second data field, and the third data field are reversely arranged related to the LSB of the time data.

9. The power-supply management method of claim 7, wherein fields of the control command comprise an address, and a content of the address is a memory address storing the time data of the power supply unit.

10. The power-supply management method of claim 7, wherein the control command is BDh command or a reserved command of Common Redundant Power Supply (CRPS).

11. The power-supply management method of claim 8, wherein lengths of the first data field, the second data field, and the third data field are respectively 8 bits, a reading length is 8 bits, and the processor assembles the first time segment, the second time segment, and the third time segment to obtain the total power-on time of length 24 bits.

12. The power-supply management method of claim 8, wherein assembling the first time segment, the second time segment, and the third time segment to obtain the total power-on time comprises utilizing a packet error check code to examine whether the total power-on time satisfies the integrity, wherein the packet error check code is 8 bits.
